(19) United States
(12) Patent Application Publication
(10) Pub. No.: US 2023/0274873 A1
(43) Pub. Date: Aug. 31, 2023

(54) TRANSFORMER AND POWER CONVERTER

(71) Applicant: FUJI ELECTRIC CO., LTD., Kawasaki-shi (JP)

(72) Inventors: Hironori OSAWA, Suzuka-shi (JP); Ryo YONEMORI, Suzuka-shi (JP); Bin HE, Suzuka-shi (JP)

(21) Appl. No.: 18/112,173

(22) Filed: Feb. 21, 2023

(30) Foreign Application Priority Data
Feb. 28, 2022 (JP) 2022-029439

(51) Int. Cl. H01F 27/28; H01F 27/32; H01F 27/30

(52) U.S. Cl. CPC H01F 27/2828; H01F 27/325; H01F 27/306

(57) ABSTRACT

A transformer includes a primary winding, a feedback winding, and a non-feedback winding having substantially equal winding widths in an axial direction of a bobbin.

### CROSS-REFERENCE TO RELATED APPLICATION

The present application claims priority of Japanese Patent Application No. 2022-029439 filed Feb. 28, 2022, the disclosure of which is hereby incorporated by reference.

### BACKGROUND OF THE INVENTION

### Field of the Invention

The present invention relates to a transformer and a power converter, and more particularly, it relates to a transformer and a power converter each including a primary winding and a plurality of secondary windings connected to different loads, respectively.

### DESCRIPTION OF THE BACKGROUND ART

A transformer including a primary winding and a plurality of secondary windings connected to different loads, respectively, is known in general, as disclosed in International Publication No. WO2019/202714, for example.

International Publication No. WO2019/202714 discloses a transformer including a primary winding and a plurality of (two) secondary windings that produces a voltage different from a voltage applied to the primary winding and is connected to different loads, respectively. International Publication No. WO2019/202714 discloses a configuration (configuration 1) in which the plurality of secondary windings includes a feedback winding to feed back an output voltage to a feedback circuit that performs feedback from the secondary winding side to the primary winding side, and a non-feedback winding other than the feedback winding. International Publication No. WO2019/202714 also discloses a configuration (configuration 2) in which a regulator is connected to the load side of each of the plurality of secondary windings to maintain the voltage constant different from the configuration 1 described above. When a regulator is used as in the configuration 2 described above, not only the regulator but also a controller or the like that controls the regulator is required.

In the transformer having the configuration 1 disclosed in International Publication No. WO2019/202714, when the output voltage fluctuates due to leakage inductance, an unintended voltage may be output to each load connected to each of the plurality of secondary windings. On the other hand, in the transformer having the configuration 2 disclosed in International Publication No. WO2019/202714, the output voltage of each of the plurality of secondary windings is maintained constant by the regulator even when the output voltage fluctuates due to the leakage inductance, and thus an intended voltage is output to each load connected to each of the plurality of secondary windings. However, the transformer having the configuration 2 disclosed in International Publication No. WO2019/202714 requires not only a voltage adjustment circuit such as a regulator, but also a controller or the like that controls the voltage adjustment circuit, and thus the number of components increases while the circuit configuration becomes complex. Therefore, it is desired to output an intended voltage to each load connected to each of the plurality of secondary windings without using a voltage adjustment circuit.

### SUMMARY OF THE INVENTION

The present invention has been proposed in order to solve the aforementioned problems, and an object of the present invention is to provide a transformer and a power converter each capable of outputting an intended voltage to each load connected to each of a plurality of secondary windings without using a voltage adjustment circuit.

In order to attain the aforementioned object, a transformer according to a first aspect of the present invention includes a primary winding, a plurality of secondary windings to generate voltages different from a voltage applied to the primary winding and to be connected to different loads, respectively, and a bobbin on which the primary winding and the plurality of secondary windings are wound in layers therearound. The plurality of secondary windings includes a feedback winding to feed back an output voltage thereof to a feedback circuit operable to perform feedback from a secondary winding side to a primary winding side, and a non-feedback winding other than the feedback winding, and the primary winding, the feedback winding, and the non-feedback winding have substantially equal winding widths in an axial direction of the bobbin.

In the transformer according to the first aspect of the present invention, as described above, the winding width of the primary winding, the winding width of the feedback winding, and the winding width of the non-feedback winding are substantially equal to each other in the axial direction of the bobbin. Accordingly, as compared with a case in which the winding widths of the primary winding, the feedback winding, and the non-feedback winding are different from each other in the axial direction of the bobbin, magnetic coupling among the primary winding, the feedback winding, and the non-feedback winding is improved. Thus, as compared with a case in which the winding widths of the primary winding, the feedback winding, and the non-feedback winding are different from each other in the axial direction of the bobbin, the leakage inductance can be decreased to decrease the amounts of change of the output voltages of the feedback winding and the non-feedback winding. Consequently, an intended voltage can be output to each load connected to each of the plurality of secondary windings without using a voltage adjustment circuit. The present inventors have already confirmed through experiments described below that the amounts of change of the output voltages of the feedback winding and the non-feedback winding can be decreased when the winding widths of the primary winding, the feedback winding, and the non-feedback winding are substantially equal to each other in the axial direction of the bobbin as compared with a case in which the winding widths of the primary winding, the feedback winding, and the non-feedback winding are different from each other in the axial direction of the bobbin.

In the transformer according to the first aspect, the primary winding, the feedback winding, and the non-feedback winding preferably have substantially the same end positions in the axial direction of the bobbin. Accordingly, as compared with a case in which the end positions of the primary winding, the feedback winding, and the non-feedback winding are different from each other in the axial direction of the bobbin, magnetic coupling among the primary winding, the feedback winding, and the non-feedback winding is improved. Thus, as compared with a case in which the end positions of the primary winding, the feedback winding, and the non-feedback winding are different from each other in the axial direction of the bobbin, the leakage inductance can be decreased to decrease the amounts of change of the output voltages of the feedback winding and the non-feedback winding. The present inventors have already confirmed through experiments described below that the amounts of change of the output voltages of the feedback winding and the non-feedback winding can be decreased when the end positions of the primary winding, the feedback winding, and the non-feedback winding are substantially the same as each other in the axial direction of the bobbin as compared with a case in which the end positions of the primary winding, the feedback winding, and the non-feedback winding are different from each other in the axial direction of the bobbin.

In the transformer according to the first aspect, the non-feedback winding preferably includes a plurality of non-feedback windings, the plurality of non-feedback windings preferably includes a first non-feedback winding to be connected to a first load so as to output a voltage with first accuracy, and a second non-feedback winding to be connected to a second load so as to output a voltage with second accuracy lower than the first accuracy, and the first non-feedback winding is preferably wound in a layer around the bobbin so as to be closer to the feedback winding than the second non-feedback winding in the radial direction of the bobbin. Accordingly, magnetic coupling between the feedback winding and the first non-feedback winding arranged relatively close to the feedback winding is increased as compared with magnetic coupling between the feedback winding and the second non-feedback winding arranged relatively far from the feedback winding. Thus, the amount of change of the output voltage of the first non-feedback winding required to output a voltage with relatively high accuracy can be decreased. The present inventors have already confirmed through experiments described below that the amounts of change of the output voltages of the non-feedback windings can be decreased as positions at which the non-feedback windings are wound around the bobbin approach a position at which the feedback winding is wound around the bobbin in the radial direction of the bobbin.

In such a case, the first non-feedback winding is preferably wound in a layer around the bobbin so as to be adjacent to the feedback winding in the radial direction of the bobbin. Accordingly, a position at which the first non-feedback winding is wound around the bobbin can be brought as close as possible to the position at which the feedback winding is wound around the bobbin in the radial direction of the bobbin, and thus the amount of change of the output voltage of the first non-feedback winding required to output a voltage with relatively high accuracy can be effectively decreased.

In the configuration in which the first non-feedback winding is wound in a layer around the bobbin so as to be adjacent to the feedback winding in the radial direction of the bobbin, the first non-feedback winding preferably includes a plurality of first non-feedback windings, and the feedback winding is preferably wound in a layer around the bobbin so as to be adjacent to the plurality of first non-feedback windings on opposite sides in the radial direction of the bobbin. Accordingly, the amounts of change of the output voltages of the two first non-feedback windings wound around the bobbin so as to be adjacent to the feedback winding in the radial direction of the bobbin can be effectively decreased.

In the transformer according to the first aspect, the primary winding preferably includes a primary first winding portion and a primary second winding portion arranged in a layer different from a layer of the primary first winding portion, and the feedback winding and the non-feedback winding are preferably wound in layers around the bobbin so as to be sandwiched between the primary first winding portion and the primary second winding portion in the radial direction of the bobbin. Accordingly, as compared with a case in which the secondary windings (the feedback winding and the non-feedback winding) are wound around the bobbin so as not to be sandwiched by the primary winding (the primary first winding portion and the primary second winding portion) from the opposite sides, magnetic coupling between the primary winding and the secondary windings is improved. Thus, the leakage inductance can be decreased to decrease the amounts of change of the output voltages of the secondary windings as compared with a case in which the secondary windings (the feedback winding and the non-feedback winding) are wound around the bobbin so as not to be sandwiched by the primary winding (the primary first winding portion and the primary second winding portion) from the opposite sides. The present inventors have already confirmed through experiments described below that the amounts of change of the output voltages of the secondary windings can be decreased when the secondary windings are wound around the bobbin so as to be sandwiched by the primary winding from the opposite sides as compared with a case in which the secondary windings are wound around the bobbin so as not to be sandwiched by the primary winding from the opposite sides.

In such a case, the non-feedback winding preferably includes a plurality of non-feedback windings, and the feedback winding is preferably wound in a layer around the bobbin so as to be sandwiched between the primary first winding portion and the primary second winding portion and sandwiched between the plurality of non-feedback windings in the radial direction of the bobbin. Accordingly, as compared with a case in which the secondary windings (the feedback winding and the non-feedback windings) are wound around the bobbin so as not to be sandwiched by the primary winding from the opposite sides, the amounts of change of the output voltages of the secondary windings can be decreased, and the amounts of change of the output voltages of the two non-feedback windings wound around the bobbin so as to be adjacent to the feedback winding can be effectively decreased.

In order to attain the aforementioned object, a power converter according to a second aspect of the present invention includes a transformer including a primary winding, a plurality of secondary windings to generate voltages different from a voltage applied to the primary winding and to be connected to different loads, respectively, and a bobbin on which the primary winding and the plurality of secondary windings are wound in layers therearound, and a feedback circuit to perform feedback from a secondary winding side to a primary winding side. The plurality of secondary windings includes a feedback winding to feed back an output voltage thereof to the feedback circuit, and a non-feedback winding other than the feedback winding, and the primary winding, the feedback winding, and the non-feedback winding have substantially equal winding widths in an axial direction of the bobbin.

In the power converter according to the second aspect of the present invention, as described above, the winding width of the primary winding, the winding width of the feedback winding, and the winding width of the non-feedback winding are substantially equal to each other in the axial direction of the bobbin, similarly to the transformer according to the first aspect. Accordingly, similarly to the transformer according to the first aspect, as compared with a case in which the winding widths of the primary winding, the feedback winding, and the non-feedback winding are different from each other in the axial direction of the bobbin, the amounts of change of the output voltages of the feedback winding and the non-feedback winding can be decreased. Consequently, similarly to the transformer according to the first aspect, an intended voltage can be output to each load connected to each of the plurality of secondary windings without using a voltage adjustment circuit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram of a power converter according to an embodiment of the present invention;

FIG. 2 is a diagram showing the configuration of a transformer of the power converter according to the embodiment of the present invention;

FIG. 3 is a diagram showing experimental results regarding a relationship between the winding widths of windings in an axial direction of a bobbin and leakage inductance;

FIG. 4 is a diagram showing experimental results regarding a relationship between the winding widths of the windings in the axial direction of the bobbin and the rates of change of output voltages;

FIG. 5 is a diagram showing experimental results regarding a relationship between the positional deviation of an end of a winding in the axial direction of the bobbin and the leakage inductance;

FIG. 6 is a diagram showing experimental results regarding a relationship between the positional deviation of the end of the winding in the axial direction of the bobbin and the rates of change of the output voltages;

FIG. 7 is a diagram showing experimental results regarding a relationship between a difference of the winding width of one winding from the winding width of each of all other windings and the leakage inductance;

FIG. 8 is a diagram showing experimental results regarding a relationship between the difference of the winding width of one winding from the winding width of each of all other windings and the rates of change of the output voltages;

FIG. 9 is a diagram illustrating an experiment on a relationship between the arrangement order of windings in the radial direction of the bobbin and the rates of change of the output voltages; and

FIG. 10 is a diagram showing experimental results regarding a relationship between the arrangement order of the windings in the radial direction of the bobbin and the rates of change of the output voltages.

### DESCRIPTION OF THE PREFERRED EMBODIMENTS

An embodiment of the present invention is hereinafter described with reference to the drawings.

### Configuration of Transformer and Power Converter

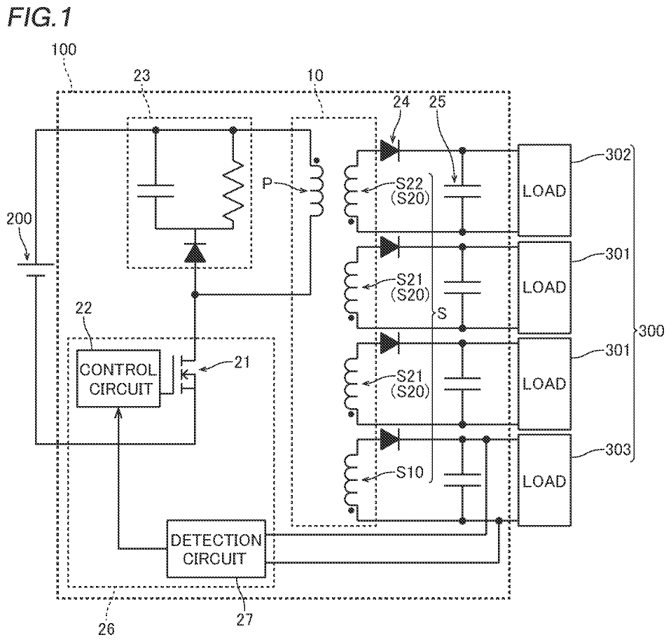

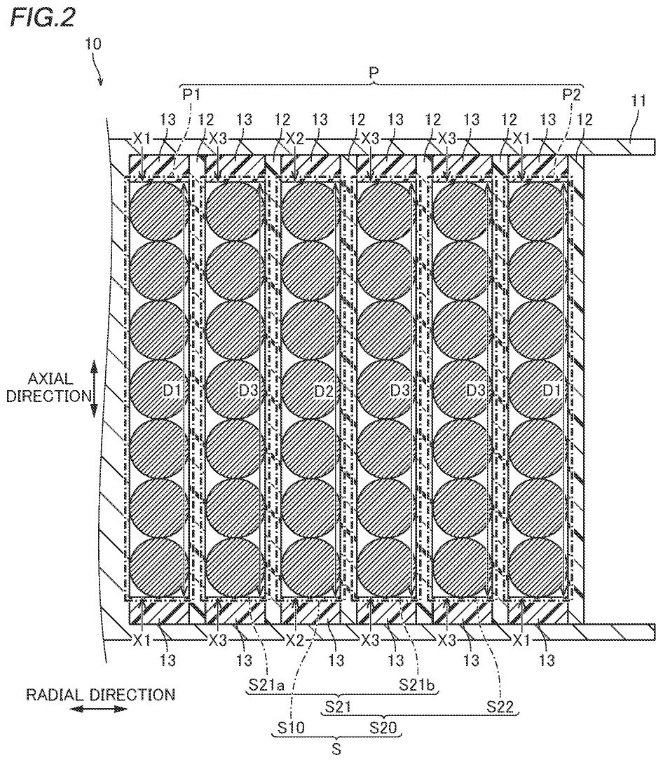

The configuration of a transformer 10 and a power converter 100 according to the embodiment of the present invention is now described with reference to FIGS. 1 and 2.

### Overall Configuration of Power Converter

As shown in FIG. 1, the power converter 100 includes the transformer 10, a switching element 21, a switching control circuit 22, a snubber circuit 23, rectifiers 24, smoothers 25, and a feedback circuit 26.

The transformer 10 includes a primary winding P and a plurality of secondary windings S. The primary winding P and the plurality of secondary windings S are insulated from each other. That is, the transformer 10 is an isolation transformer.

The primary winding P is provided on the primary side of the transformer 10. A current is supplied from a power supply 200 to the primary winding P via the switching element 21.

The plurality of secondary windings S is provided on the secondary side of the transformer 10. The plurality of secondary windings S produces a voltage different from a voltage applied to the primary winding P. The plurality of secondary windings S is connected to different loads 300, respectively.

The plurality of secondary windings S includes a feedback winding S10 to feed back an output voltage to the feedback circuit 26 and non-feedback windings S20 other than the feedback winding S10. A plurality of (three) non-feedback windings S20 is provided.

As shown in FIG. 2, the transformer 10 includes a bobbin 11. The primary winding P and the plurality of secondary windings S are wound in layers around the bobbin 11. That is, the primary winding P and the plurality of secondary windings S are wound in layers around the bobbin 11 so as to be aligned from the inside to the outside in the radial direction of the bobbin 11. An insulating tape 12 is provided between the primary winding P and the plurality of secondary windings S adjacent to each other in the radial direction of the bobbin 11 to insulate the windings from each other.

As shown in FIG. 1, the switching element 21 is controlled by the switching control circuit 22 and switched (ON/OFF). The switching of the switching element 21 is controlled such that a current (excitation current) to be supplied to the primary winding P is adjusted.

The snubber circuit 23 is connected to the switching element 21. The snubber circuit 23 includes a diode, a capacitor, and a resistor. The snubber circuit 23 absorbs a transient high voltage caused by switching of the switching element 21.

The rectifiers 24 and the smoothers 25 are connected between the plurality of secondary windings S and a plurality of loads 300. The rectifiers 24 each includes a diode. The rectifiers 24 rectify the output voltages of the plurality of secondary windings S. The smoothers 25 each include a capacitor. The smoothers 25 smooth the output voltages of the plurality of secondary windings S.

The feedback circuit 26 performs feedback from the secondary winding S side to the primary winding P side. The feedback circuit 26 includes a detection circuit 27, and the switching element 21 and the switching control circuit 22, both of which are described above. The detection circuit 27 detects the output voltage of the feedback winding S10 and inputs the detected output voltage of the feedback winding S10 to the switching control circuit 22. The switching control circuit 22 switches the switching element 21 based on the input output voltage of the feedback winding S10.

### Detailed Configuration of Transformer

As shown in FIG. 2, the winding width D1 of the primary winding P in the axial direction of the bobbin 11, the winding width D2 of the feedback winding S10 in the axial direction of the bobbin 11, and the winding width D3 of each of the non-feedback windings S20 in the axial direction of the bobbin 11 are substantially equal to each other. Each of the primary winding P, the feedback winding S10, and the non-feedback windings S20 is wound in a regular fashion so as to eliminate variations in a winding method in the axial direction of the bobbin 11.

The end position X1 of the primary winding P in the axial direction of the bobbin 11, the end position X2 of the feedback winding S10 in the axial direction of the bobbin 11, and the end positions X3 of the non-feedback windings S20 in the axial direction of the bobbin 11 are substantially the same. Specifically, barrier tapes 13 are provided at the opposite ends of each of the primary winding P, the feedback winding S10, and the non-feedback windings S20 in the axial direction of the bobbin 11 to ensure a creepage distance for insulation between the windings. The positions of the barrier tapes 13 in the axial direction of the bobbin 11 are substantially the same. Each of the primary winding P, the feedback winding S10, and the non-feedback windings S20 contacts the barrier tapes 13 at the opposite ends in the axial direction of the bobbin 11. That is, each of the primary winding P, the feedback winding S10, and the non-feedback windings S20 is arranged over the entire windable range of the bobbin 11 in the axial direction.

The primary winding P includes a primary first winding portion P1 and a primary second winding portion P2 arranged in a layer different from a layer of the primary first winding portion P1. The primary first winding portion P1 is arranged on the innermost side in the radial direction of the bobbin 11. The primary second winding portion P2 is arranged on the outermost side in the radial direction of the bobbin 11. The feedback winding S10 and the non-feedback windings S20 are wound in layers around the bobbin 11 so as to be sandwiched between the primary first winding portion P1 and the primary second winding portion P2 in the radial direction of the bobbin 11.

As shown in FIG. 1, the plurality of non-feedback windings S20 includes first non-feedback windings S21 and a second non-feedback winding S22. The first non-feedback windings S21 are connected to loads 301 so as to output a voltage with first accuracy. The loads 301 are power supplies used for a microcomputer or power supplies used for a circuit that produces a reference voltage for control, for example. The second non-feedback winding S22 is connected to a load 302 so as to output a voltage with second accuracy lower than the first accuracy. The load 302 is a power supply that drives a fan or a power supply that drives a relay, for example. The loads 301 and the load 302 are examples of a “first load” and a “second load” in the claims, respectively. The feedback winding S10 is connected to a load 303 so as to output a voltage with relatively high accuracy (accuracy substantially the same as the first accuracy, for example).

A plurality of first non-feedback windings S21 is provided. Specifically, as shown in FIG. 2, the first non-feedback windings S21 include a first non-feedback winding S21a and a first non-feedback winding S21b.

The first non-feedback windings S21 (S21a and S21b) are wound in layers around the bobbin 11 so as to be closer to the feedback winding S10 than the second non-feedback winding S22 in the radial direction of the bobbin 11. Specifically, the first non-feedback windings S21 (S21a and S21b) are wound in layers around the bobbin 11 so as to be adjacent to the feedback winding S10 in the radial direction of the bobbin 11. The feedback winding S10 is wound in a layer around the bobbin 11 so as to be adjacent to the first non-feedback windings S21 (S21a and S21b) on both sides in the radial direction of the bobbin 11. That is, the feedback winding S10 is wound in a layer around the bobbin 11 so as to be sandwiched between the plurality of first non-feedback windings S21 (S21a and S21b) in the radial direction of the bobbin 11. Specifically, the primary first winding portion P1 (primary winding P), the first non-feedback winding S21a, the feedback winding S10, the first non-feedback winding S21b, the second non-feedback winding S22, and the primary second winding portion P2 (primary winding P) are wound in layers around the bobbin 11 so as to be aligned in this order from the inside to the outside in the radial direction of the bobbin 11.

### Experimental Results Regarding Rate of Change (Amount of Change) of Output Voltage, etc.

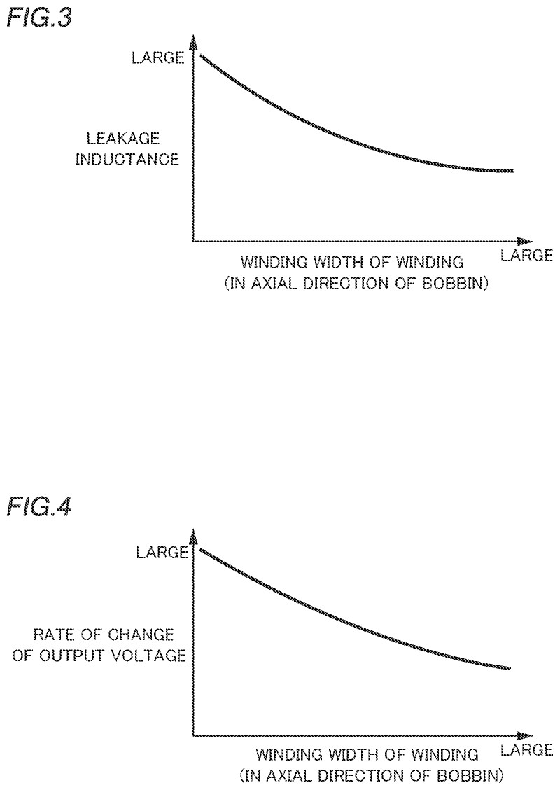

Experimental results regarding leakage inductance and the rates of change (amounts of change) of the output voltages are described with reference to FIGS. 3 to 10.

Relationship between Winding Width of Winding in Axial Direction of Bobbin and both Leakage Inductance and Rate of Change of Output Voltage

As shown in FIGS. 3 and 4, an experiment (experiment 1) was performed to confirm changes in the leakage inductance and the rates of change (amounts of change) of the output voltages while the winding widths of all the windings in the axial direction of the bobbin 11 were changed. The experiment 1 was performed with a configuration (hereinafter referred to as a configuration A) in which the primary winding P, the primary winding P, the feedback winding S10, the non-feedback winding S20, the non-feedback winding S20, and the non-feedback winding S20 are wound in layers around the bobbin 11 so as to be aligned in this order from the inside to the outside in the radial direction of the bobbin 11. In the experiment 1, the leakage inductance and the rates of change of the output voltages of the secondary windings S (the feedback winding S10 and the non-feedback windings S20) were confirmed while the winding widths of all the windings in the axial direction of the bobbin 11 were changed. The experiment 1 was performed in a state in which the primary winding P, the feedback winding S10, and the non-feedback windings S20 had substantially the same winding width in the axial direction of the bobbin 11, and the end positions of the primary winding P, the feedback winding S10, and the non-feedback windings S20 in the axial direction of the bobbin 11 were substantially the same as each other.

As shown in FIG. 3, it has been confirmable that as the winding widths of the windings in the axial direction of the bobbin 11 increase, the leakage inductance of the windings decreases. As shown in FIG. 4, it has been confirmable that as the winding widths of the windings in the axial direction of the bobbin 11 increase, the rates of change of the output voltages of the windings decrease. That is, it has been confirmable that the winding widths of the windings in the axial direction of the bobbin 11 are increased as much as possible such that the rates of change (amounts of change) of the output voltages of the secondary windings S (the feedback winding S10 and the non-feedback windings S20) can be decreased.

Relationship between Positional Deviation of End of Winding in Axial Direction of Bobbin and both Leakage Inductance and Rate of Change of Output Voltage

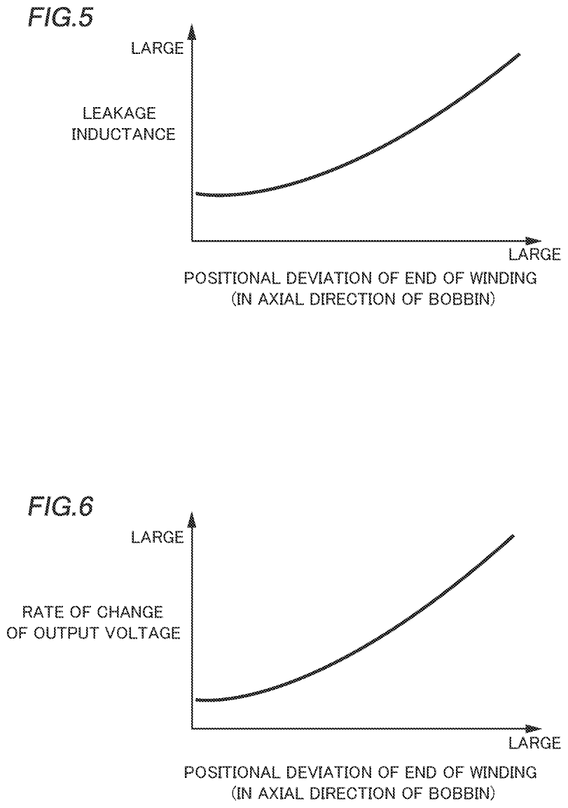

As shown in FIGS. 5 and 6, an experiment (experiment 2) was performed to confirm changes in the leakage inductance and the rates of change (amounts of change) of the output voltages while the end position of one winding in the axial direction of the bobbin 11 was changed. The experiment 2 was performed with the configuration A described above. In the experiment 2, the leakage inductance and the rate of change of the output voltage of the secondary windings S (the feedback winding S10 and the non-feedback windings S20) were confirmed while the end position of one non-feedback winding S20 in the axial direction of the bobbin 11 was changed. The experiment 2 was performed in a state in which the primary winding P, the feedback winding S10, and the non-feedback windings S20 had substantially the same winding width in the axial direction of the bobbin 11, and in the axial direction of the bobbin 11, the end positions of the windings other than the winding, the end position of which was changed, were substantially the same as each other.

As shown in FIG. 5, it has been confirmable that the leakage inductance of the windings increases as the positional deviation of the end of the winding in the axial direction of the bobbin 11 increases. In addition, it has been confirmable that the leakage inductance of the windings does not change much when the positional deviation of the end of the winding in the axial direction of the bobbin 11 is minute as compared with a case in which the end position of the winding in the axial direction of the bobbin 11 is not deviated.

As shown in FIG. 6, it has been confirmable that as the positional deviation of the end of the winding in the axial direction of the bobbin 11 increases, the rates of change (amounts of change) of the output voltages of the windings increase. That is, it has been confirmable that the end positions of the primary winding P, the feedback winding S10, and the non-feedback windings S20 are substantially the same as each other in the axial direction of the bobbin 11 such that the rates of change (amounts of change) of the output voltages of the feedback winding S10 and the non-feedback windings S20 can be decreased as compared with a case in which the end positions of the primary winding P, the feedback winding S10, and the non-feedback windings S20 are different from each other in the axial direction of the bobbin 11. In addition, it has been confirmable that the rates of change of the output voltages of the windings do not change much when the positional deviation of the end of the winding in the axial direction of the bobbin 11 is minute as compared with a case in which the end position of the winding in the axial direction of the bobbin 11 is not deviated.

Relationship Between Difference of Winding Width of One Winding from Winding Widths of all Other Windings and Both Leakage Inductance and Rate of Change (Amount of Change) of Output Voltage

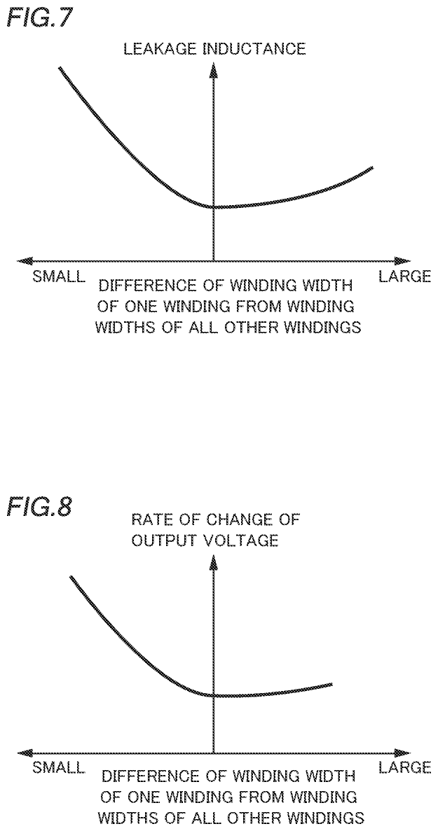

As shown in FIGS. 7 and 8, an experiment (experiment 3) was performed to confirm a change in the leakage inductance and the rates of change (amounts of change) of the output voltages while the winding width of one winding was changed. The experiment 3 was performed with the configuration A described above. In the experiment 3, the leakage inductance and the rates of change of the output voltages of the secondary windings S (the feedback winding S10 and the non-feedback windings S20) were confirmed while the winding width of one non-feedback winding S20 was changed. The experiment 3 was performed in a state in which the winding widths of the windings other than the winding, the winding width of which was changed, were substantially equal to each other in the axial direction of the bobbin 11.

As shown in FIG. 7, it has been confirmable that as the winding width of one winding greatly differs from the winding widths of all other windings, the leakage inductance of the windings increases. In addition, it has been confirmable that an increase in the leakage inductance of the windings is small when the winding width of one winding is increased relative to the winding widths of all other windings as compared with a case in which the winding width of one winding is decreased relative to the winding widths of all other windings.

As shown in FIG. 8, it has been confirmable that as the winding width of one winding greatly differs from the winding widths of all other windings, the rates of change (amounts of change) of the output voltages of the windings increase. That is, it has been confirmable that the winding widths of the primary winding P, the feedback winding S10, and the non-feedback windings S20 are substantially equal to each other in the axial direction of the bobbin 11 such that the rates of change (amounts of change) of the output voltages of the feedback winding S10 and the non-feedback windings S20 can be decreased as compared with a case in which the winding widths of the primary winding P, the feedback winding S10, and the non-feedback windings S20 are different from each other in the axial direction of the bobbin 11. In addition, it has been confirmable that an increase in the rates of change of the output voltages of the windings is small when the winding width of one winding is increased relative to the winding widths of all other windings as compared with a case in which the winding width of one winding is decreased relative to the winding widths of all other windings.

### Relationship Between Arrangement Order of Windings in Plane Perpendicular to Axial Direction of Bobbin and Rate of Change (Amount of Change) of Output Voltage

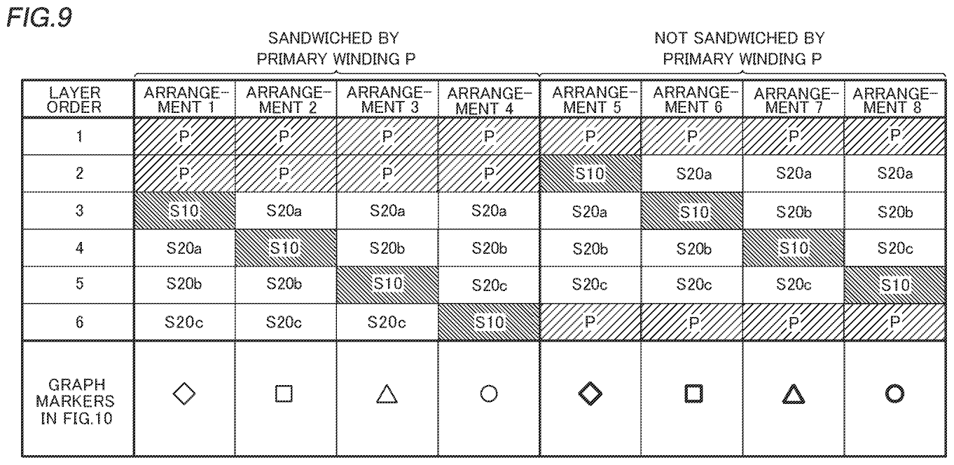

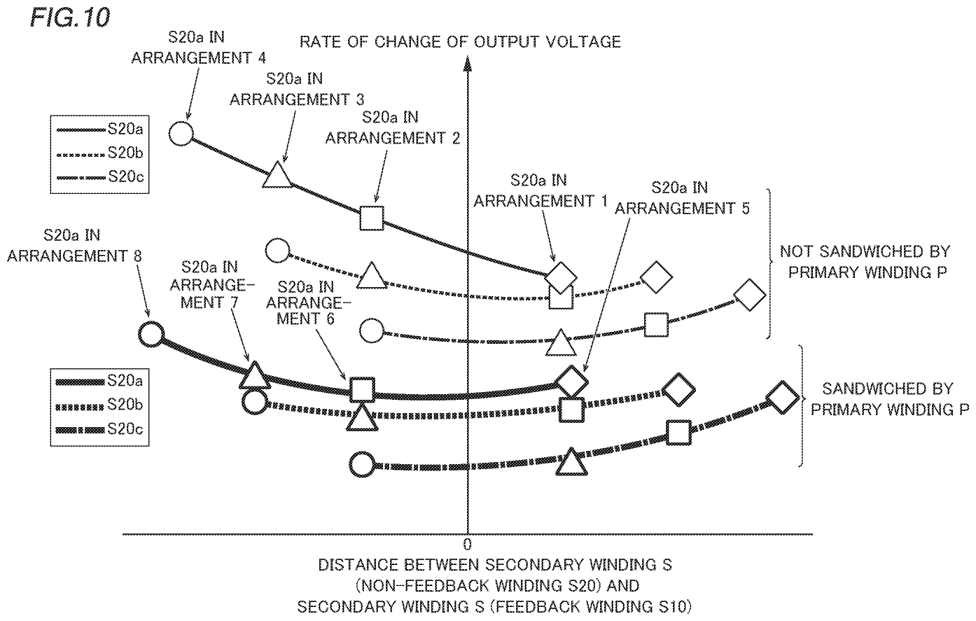

As shown in FIGS. 9 and 10, an experiment (experiment 4) was performed to confirm the rates of change (amounts of change) of the output voltages while the arrangement order of the windings in a plane perpendicular to the axial direction of the bobbin 11 is changed. In the experiment 4, the rates of change of the output voltages of the windings were confirmed while the arrangement order of the windings in the plane perpendicular to the axial direction of the bobbin 11 is changed to each of arrangements 1 to 8. As shown in FIG. 9, in the arrangements 1 to 4, the secondary windings S (the feedback winding S10 and the non-feedback windings S20) are not sandwiched by the primary winding P. On the other hand, in the arrangements 5 to 8, the secondary windings S (the feedback winding S10 and the non-feedback windings S20) are sandwiched by the primary winding P. In FIGS. 9 and 10, the three non-feedback windings S20 are shown as S20a, S20b, and S20c to be distinguished from each other.

Specifically, the arrangement 1 has the same configuration as the configuration A described above. In the arrangement 2, the primary winding P, the primary winding P, the non-feedback winding S20, the feedback winding S10, the non-feedback winding S20, and the non-feedback winding S20 are wound in layers around the bobbin 11 so as to be aligned in this order from the inside to the outside in the radial direction of the bobbin 11. In the arrangement 3, the primary winding P, the primary winding P, the non-feedback winding S20, the non-feedback winding S20, the feedback winding S10, and the non-feedback winding S20 are wound in layers around the bobbin 11 so as to be aligned in this order from the inside to the outside in the radial direction of the bobbin 11. In the arrangement 4, the primary winding P, the primary winding P, the non-feedback winding S20, the non-feedback winding S20, the non-feedback winding S20, and the feedback winding S10 are wound in layers around the bobbin 11 so as to be aligned in this order from the inside to the outside in the radial direction of the bobbin 11.

In the arrangement 5, the primary winding P, the feedback winding S10, the non-feedback winding S20, the non-feedback winding S20, the non-feedback winding S20, and the primary winding P are wound in layers around the bobbin 11 so as to be aligned in this order from the inside to the outside in the radial direction of the bobbin 11. In the arrangement 6, the primary winding P, the non-feedback winding S20, the feedback winding S10, the non-feedback winding S20, the non-feedback winding S20, and the primary winding P are wound in layers around the bobbin 11 so as to be aligned in this order from the inside to the outside in the radial direction of the bobbin 11. In the arrangement 7, the primary winding P, the non-feedback winding S20, the non-feedback winding S20, the feedback winding S10, the non-feedback winding S20, and the primary winding P are wound in layers around the bobbin 11 so as to be aligned in this order from the inside to the outside in the radial direction of the bobbin 11. In the arrangement 8, the primary winding P, the non-feedback winding S20, the non-feedback winding S20, the non-feedback winding S20, the feedback winding S10, and the primary winding P are wound in layers around the bobbin 11 so as to be aligned in this order from the inside to the outside in the radial direction of the bobbin 11.

As shown in FIG. 10, it has been confirmable that in the arrangements 5 to 8, the rates of change (amounts of change) of the output voltages of the secondary windings S (the feedback winding S10 and the non-feedback windings S20) are decreased as compared with the arrangements 1 to 4. For example, the rate of change of the output voltage of the non-feedback winding S20a in the arrangements 5 to 8 is smaller than the rate of change of the output voltage of the non-feedback winding S20a in the arrangements 1 to 4. That is, it has been confirmable that the rates of change (amounts of change) of the output voltages of the secondary windings S can be decreased when the secondary windings S (the feedback winding S10 and the non-feedback windings S20) are wound around the bobbin 11 so as to be sandwiched by the primary winding P from opposite sides as compared with a case in which the secondary windings S are wound around the bobbin 11 so as not to be sandwiched by the primary winding P from the opposite sides. It has been confirmable that as the non-feedback windings S20 are arranged closer to the feedback winding S10, the rates of change of the output voltages are decreased. For example, in response to gradually increasing a distance between the non-feedback winding S20a and the feedback winding S10 in the order of the arrangement 2, the arrangement 3, and the arrangement 4, the rate of change of the output voltage of the non-feedback winding S20a is gradually increased. Furthermore, in response to gradually increasing a distance between the non-feedback winding S20a and the feedback winding S10 in the order of the arrangement 6, the arrangement 7, and the arrangement 8, the rate of change of the output voltage of the non-feedback winding S20a is gradually increased. That is, it has been confirmable that the rates of change (amounts of change) of the output voltages of the non-feedback windings S20 can be decreased as positions at which the non-feedback windings S20 are wound around the bobbin 11 approach a position at which the feedback winding S10 is wound around the bobbin 11 in the radial direction of the bobbin 11.

### Advantageous Effects of Embodiment

According to this embodiment, the following advantageous effects are achieved.

According to this embodiment, as described above, the winding width D1 of the primary winding P, the winding width D2 of the feedback winding S10, and the winding widths D3 of the non-feedback windings S20 are substantially equal to each other in the axial direction of the bobbin 11. Accordingly, as compared with a case in which the winding widths of the primary winding P, the feedback winding S10, and the non-feedback windings S20 are different from each other in the axial direction of the bobbin 11, magnetic coupling among the primary winding P, the feedback winding S10, and the non-feedback windings S20 is improved. Thus, as compared with a case in which the winding widths of the primary winding P, the feedback winding S10, and the non-feedback windings S20 are different from each other in the axial direction of the bobbin 11, the leakage inductance can be decreased to decrease the amounts of change of the output voltages of the feedback winding S10 and the non-feedback windings S20. Consequently, an intended voltage can be output to each load 300 connected to each of the plurality of secondary windings S without using a voltage adjustment circuit.

According to this embodiment, as described above, the end position X1 of the primary winding P, the end position X2 of the feedback winding S10, and the end positions X3 of the non-feedback windings S20 are substantially the same as each other in the axial direction of the bobbin 11. Accordingly, as compared with a case in which the end positions of the primary winding P, the feedback winding S10, and the non-feedback windings S20 are different from each other in the axial direction of the bobbin 11, magnetic coupling among the primary winding P, the feedback winding S10, and the non-feedback windings S20 is improved. Thus, as compared with a case in which the end positions of the primary winding P, the feedback winding S10, and the non-feedback windings S20 are different from each other in the axial direction of the bobbin 11, the leakage inductance can be decreased to decrease the amounts of change of the output voltages of the feedback winding S10 and the non-feedback windings S20.

According to this embodiment, as described above, the plurality of non-feedback windings S20 is provided. The plurality of non-feedback windings S20 includes the first non-feedback windings S21 connected to the loads 301 so as to output a voltage with the first accuracy, and the second non-feedback winding S22 connected to the load 302 so as to output a voltage with the second accuracy lower than the first accuracy. The first non-feedback windings S21 are wound in layers around the bobbin 11 so as to be closer to the feedback winding S10 than the second non-feedback winding S22 in the radial direction of the bobbin 11. Accordingly, magnetic coupling between the feedback winding S10 and the first non-feedback windings S21 arranged relatively close to the feedback winding S10 is increased as compared with magnetic coupling between the feedback winding S10 and the second non-feedback winding S22 arranged relatively far from the feedback winding S10. Thus, the amounts of change of the output voltages of the first non-feedback windings S21 required to output a voltage with relatively high accuracy can be decreased.

According to this embodiment, as described above, the first non-feedback windings S21 are wound in layers around the bobbin 11 so as to be adjacent to the feedback winding S10 in the radial direction of the bobbin 11. Accordingly, the positions at which the first non-feedback windings S21 are wound around the bobbin 11 can be brought as close as possible to the position at which the feedback winding S10 is wound around the bobbin 11 in the radial direction of the bobbin 11, and thus the amounts of change of the output voltages of the first non-feedback windings S21 required to output a voltage with relatively high accuracy can be effectively decreased.

According to this embodiment, as described above, the plurality of first non-feedback windings S21 is provided. The feedback winding S10 is wound in a layer around the bobbin 11 so as to be adjacent to the first non-feedback windings S21 (S21a and S21b) on the opposite sides in the radial direction of the bobbin 11. Accordingly, the amounts of change of the output voltages of the two first non-feedback windings S21 (S21a and S21b) wound around the bobbin 11 so as to be adjacent to the feedback winding S10 in the radial direction of the bobbin 11 can be effectively decreased.

According to this embodiment, as described above, the primary winding P includes the primary first winding portion P1 and the primary second winding portion P2 arranged in the layer different from the layer of the primary first winding portion P1. The feedback winding S10 and the non-feedback windings S20 are wound in layers around the bobbin 11 so as to be sandwiched between the primary first winding portion P1 and the primary second winding portion P2 in the radial direction of the bobbin 11. Accordingly, as compared with a case in which the secondary windings S (the feedback winding S10 and the non-feedback windings S20) are wound around the bobbin 11 so as not to be sandwiched by the primary winding P (the primary first winding portion P1 and the primary second winding portion P2) from the opposite sides, magnetic coupling between the primary winding P and the secondary windings S is improved. Thus, the leakage inductance can be decreased to decrease the amounts of change of the output voltages of the secondary windings S as compared with a case in which the secondary windings S (the feedback winding S10 and the non-feedback windings S20) are wound around the bobbin 11 so as not to be sandwiched by the primary winding P (the primary first winding portion P1 and the primary second winding portion P2) from the opposite sides.

According to this embodiment, as described above, the plurality of non-feedback windings S20 is provided. The feedback winding S10 is wound in a layer around the bobbin 11 so as to be sandwiched between the primary first winding portion P1 and the primary second winding portion P2 and sandwiched between the plurality of non-feedback windings S20 in the radial direction of the bobbin 11. Accordingly, as compared with a case in which the secondary windings S (the feedback winding S10 and the non-feedback windings S20) are wound around the bobbin 11 so as not to be sandwiched by the primary winding P from the opposite sides, the amounts of change of the output voltages of the secondary windings S can be decreased, and the amounts of change of the output voltages of the two non-feedback windings S20 wound around the bobbin 11 so as to be adjacent to the feedback winding S10 can be effectively decreased.

### Modified Examples

The embodiment disclosed this time must be considered as illustrative in all points and not restrictive. The scope of the present invention is not shown by the above description of the embodiment but by the scope of claims for patent, and all modifications (modified examples) within the meaning and scope equivalent to the scope of claims for patent are further included.

For example, while the feedback winding S10 and the non-feedback windings S20 are wound in layers around the bobbin 11 so as to be sandwiched between the primary first winding portion P1 and the primary second winding portion P2 in the radial direction of the bobbin 11 in the aforementioned embodiment, the present invention is not limited to this. In the present invention, the feedback winding and the non-feedback windings may alternatively be wound in layers around the bobbin so as not to be sandwiched between the primary winding first winding portion and the primary winding second winding portion in the radial direction of the bobbin.

While the primary winding P includes the primary first winding portion P1 and the primary second winding portion P2 arranged in the layer different from the layer of the primary first winding portion P1 in the aforementioned embodiment, the present invention is not limited to this. In the present invention, the primary winding may not include the primary second winding portion arranged in the layer different from the layer of the primary first winding portion. That is, the primary winding may include only the primary first winding portion.

While the feedback winding S10 is wound in a layer around the bobbin 11 so as to be adjacent to the first non-feedback windings S21 (S21a and S21b) on the opposite sides in the radial direction of the bobbin 11 in the aforementioned embodiment, the present invention is not limited to this. In the present invention, the feedback winding may alternatively be wound in layers around the bobbin so as to be adjacent to the first non-feedback windings on one side in the radial direction of the bobbin.

While the first non-feedback windings S21 are wound in layers around the bobbin 11 so as to be adjacent to the feedback winding S10 in the radial direction of the bobbin 11 in the aforementioned embodiment, the present invention is not limited to this. In the present invention, the first non-feedback windings may alternatively be wound in layers around the bobbin so as not to be adjacent to the feedback winding in the radial direction of the bobbin.

While the first non-feedback windings S21 are wound in layers around the bobbin 11 so as to be closer to the feedback winding S10 than the second non-feedback winding S22 in the radial direction of the bobbin 11 in the aforementioned embodiment, the present invention is not limited to this. In the present invention, the first non-feedback windings may alternatively be wound in layers around the bobbin so as to be farther from the feedback winding than the second non-feedback winding in the radial direction of the bobbin.

While the plurality of non-feedback windings S20 includes the first non-feedback windings S21 connected to the loads 301 (first load) so as to output a voltage with the first accuracy, and the second non-feedback winding S22 connected to the load 302 (second load) so as to output a voltage with the second accuracy lower than the first accuracy in the aforementioned embodiment, the present invention is not limited to this. In the present invention, each of the plurality of non-feedback windings may alternatively be connected to each load so as to output a voltage with the first (relatively high) accuracy.

While three non-feedback windings S20 are provided in the aforementioned embodiment, the present invention is not limited to this. In the present invention, two or four or more non-feedback windings may alternatively be provided.

While the plurality of non-feedback windings S20 is provided in the aforementioned embodiment, the present invention is not limited to this. In the present invention, only one non-feedback winding may alternatively be provided.

While the end position X1 of the primary winding P, the end position X2 of the feedback winding S10, and the end positions X3 of the non-feedback windings S20 are substantially the same as each other in the axial direction of the bobbin 11 in the aforementioned embodiment, the present invention is not limited to this. In the present invention, the end position of the primary winding, the end position of the feedback winding, and the end positions of the non-feedback windings may alternatively be different from each other in the axial direction of the bobbin.

What is claimed is:

1. A transformer comprising:
a primary winding;
a plurality of secondary windings to generate voltages different from a voltage applied to the primary winding and to be connected to different loads, respectively; and
a bobbin on which the primary winding and the plurality of secondary windings are wound in layers therearound; wherein
the plurality of secondary windings includes a feedback winding to feed back an output voltage thereof to a feedback circuit operable to perform feedback from a secondary winding side to a primary winding side, and a non-feedback winding other than the feedback winding; and
the primary winding, the feedback winding, and the non-feedback winding have substantially equal winding widths in an axial direction of the bobbin.

2. The transformer according to claim 1, wherein the primary winding, the feedback winding, and the non-feedback winding have substantially the same end positions in the axial direction of the bobbin.

3. The transformer according to claim 1, wherein
the non-feedback winding includes a plurality of non-feedback windings;
the plurality of non-feedback windings includes a first non-feedback winding to be connected to a first load so as to output a voltage with first accuracy, and a second non-feedback winding to be connected to a second load so as to output a voltage with second accuracy lower than the first accuracy; and
the first non-feedback winding is wound in a layer around the bobbin so as to be closer to the feedback winding than the second non-feedback winding in a radial direction of the bobbin.

4. The transformer according to claim 3, wherein the first non-feedback winding is wound in a layer around the bobbin so as to be adjacent to the feedback winding in the radial direction of the bobbin.

5. The transformer according to claim 4, wherein
the first non-feedback winding includes a plurality of first non-feedback windings; and
the feedback winding is wound in a layer around the bobbin so as to be adjacent to the plurality of first non-feedback windings on opposite sides in the radial direction of the bobbin.

6. The transformer according to claim 1, wherein
the primary winding includes a primary first winding portion and a primary second winding portion arranged in a layer different from a layer of the primary first winding portion; and
the feedback winding and the non-feedback winding are wound in layers around the bobbin so as to be sandwiched between the primary first winding portion and the primary second winding portion in a radial direction of the bobbin.

7. The transformer according to claim 6, wherein
the non-feedback winding includes a plurality of non-feedback windings; and
the feedback winding is wound in a layer around the bobbin so as to be sandwiched between the primary first winding portion and the primary second winding portion and sandwiched between the plurality of non-feedback windings in the radial direction of the bobbin.

8. A power converter comprising:
a transformer including a primary winding, a plurality of secondary windings to generate voltages different from a voltage applied to the primary winding and to be connected to different loads, respectively, and a bobbin on which the primary winding and the plurality of secondary windings are wound in layers therearound; and
a feedback circuit to perform feedback from a secondary winding side to a primary winding side; wherein
the plurality of secondary windings includes a feedback winding to feed back an output voltage thereof to the feedback circuit, and a non-feedback winding other than the feedback winding; and
the primary winding, the feedback winding, and the non-feedback winding have substantially equal winding widths in an axial direction of the bobbin.
